(19) United States
(12) Patent Application Publication
(10) Pub. No.: US 2012/0213983 A1
(43) Pub. Date: Aug. 23, 2012

(54) MATERIALS AND METHOD UTILIZING SHORT CARBON NANOTUBES IN TRANSPARENT PRINTED ELECTRONICS

(75) Inventor: Molly Hladik, Nixa, MO (US)

(73) Assignee: BREWER SCIENCE INC., Rolla, MO (US)

(21) Appl. No.: 13/402,503

(22) Filed: Feb. 22, 2012

Related U.S. Application Data
(60) Provisional application No. 61/445,399, filed on Feb. 22, 2011.

(51) Int. Cl. B05D 5/12; D01F 9/12; B82Y 30/00; B82Y 40/00

(52) U.S. Cl. 428/220; 423/447.1; 427/122; 977/742; 977/842; 977/847

(57) ABSTRACT

A method of increasing the conductivity and/or transparency of a transparent, conductive film using short carbon nanotubes (≦600 nm) is provided. Methods of forming flexible, transparent, conductive films and the resulting structures thereby formed are also provided.

### CROSS-REFERENCE TO RELATED APPLICATIONS

The present application claims the priority benefit of U.S. Provisional Patent Application Ser. No. 61/445,399, filed Feb. 22, 2011, entitled MATERIALS AND METHOD UTILIZING SHORT CARBON NANOTUBES IN TRANSPARENT PRINTED ELECTRONICS, incorporated by reference in its entirety herein.

### BACKGROUND OF THE INVENTION

1. Field of the Invention

The present invention relates to the use of short carbon nanotubes to increase transparency of printed conductive media without significantly decreasing conductivity (and vice versa).

2. Description of Related Art

Current transparent conductive films are formed using transparent conducting oxides, such as indium-tin oxide (ITO), which forms a brittle film and thus limits its use to substrates that are rigid. ITO is also typically applied via a chemical vapor deposition (CVD) process that is expensive, time consuming, and limited to the size of the CVD chamber. In addition, in virtually all transparent conducting films, a compromise must be made between conductivity and transparency, since increasing the thickness and increasing the concentration of charge carriers will increase the material's conductivity, but decrease its transparency. Thus, there is a continuing need for improved materials and methods of forming transparent conducting films. For example, in order to facilitate flexible displays and other emerging electronics, a flexible transparent conductive material is needed.

Carbon nanotubes (CNTs) are one option being explored for use as a replacement transparent conductive material, and are being used with increasing frequency in printed microelectronics. CNTs can be single-walled (SWNTs), double-walled (DWNTs), multi-walled (MWNTs), and/or thin-walled (TWNTs). CNT solutions and composites can be almost completely transparent at low CNT concentrations. However, as higher concentrations or multiple layers of CNTs are used to increase conductivity, the transparency can drop, and the printed circuits and electrodes are visible on otherwise transparent substrates. Therefore, it is generally desirable to use lower concentrations of CNTs to obtain maximum transparency, or otherwise decrease the absorption of the conductive CNT solutions. Current CNT research and development is also trending toward the use of longer CNTs in order to achieve higher conductivity at lower concentrations. However, these longer tubes have issues with high defectivity and poor dispersion.

### SUMMARY OF THE INVENTION

The present invention is broadly concerned with a method of increasing conductivity of a transparent, conductive film without significantly decreasing transparency. The method comprises providing a composition comprising a first plurality of carbon nanotubes and a plurality of short carbon nanotubes, and forming a film from the composition.

A method of forming a transparent, conductive film is also provided. The method comprises providing a substrate having a surface and a precursor composition comprising a plurality of short carbon nanotubes in a carrier. A layer of the precursor composition is formed adjacent the substrate surface, and the carrier is removed to yield the film.

An article comprising a substrate having a surface and a transparent conductive film adjacent the substrate surface is also provided. The transparent, conductive film comprises a plurality of short carbon nanotubes.

### DETAILED DESCRIPTION

The present invention is concerned with methods of increasing the conductivity of a transparent, conductive material using a higher concentration of CNTs, without significantly decreasing transparency. As used herein, a “significant” decrease in transparency is defined as a decrease in % transmittance of the resulting film (as compared to the original % transmittance of the film) of greater than about 15%. Likewise, the invention is concerned with increasing transparency without significantly decreasing conductivity. As used herein, a “significant” decrease in conductivity is defined as an increase in sheet resistance of the resulting film (as compared to the original sheet resistance of the film) of greater than about 20%. In particular, the invention is concerned with the use of short CNTs, as defined herein, to increase the overall CNT concentration to achieve the desired conductivity, while also achieving a higher transparency over traditional transparent conductive material formed using long CNTs, as that term is defined herein. The invention is also concerned with mixtures of short and long CNTs, wherein the properties of the standard (long) CNTs dominate the bulk properties of the solution, but small improvements in resistance can be achieved via the presence of the short CNTs without negatively affecting the overall transmittance of the coating. Flexible, transparent, conductive films and structures formed using these films are also contemplated by the present invention.

In one aspect, a plurality of short CNTs are distributed in a carrier to form a precursor composition. In one or more embodiments, a plurality of long CNTs can also be distributed in the carrier with the short CNTs. The weight ratio of short to long CNTs (when present) is preferably from about 1:4 to about 5:1, more preferably from about 1:2 to about 3:1, and even more preferably from about 1:1 to about 2:1. As used herein, the term “short” CNTs refers to carbon nanotubes having a nominal individual tube length of less than about 600 nm, more preferably less than about 400 nm, even more preferably less than about 300 nm, and most preferably from about 1 nm to about 300 nm. The term “long” CNTs is used herein to refer to both standard and long carbon nanotubes having a nominal individual tube length of greater than about 1 μm, more preferably from about 1 μm to about 30 μm, and even more preferably from about 2 μm to about 20 μm. It will be appreciated that CNTs of a given tube length are commercially available as polydisperse mixtures of varying individual tube lengths. In other words, a plurality of “short” CNTs may actually contain some portion of CNTs that are longer than the above-defined threshold. Likewise, a plurality of “long” CNTs may actually contain some portion of CNTs that are shorter than the above-defined threshold. Thus, the “nominal” individual tube length, as used herein, of a plurality of CNTs refers to the mode of the plurality of CNTs. In some embodiments, the composition can be substantially free of long CNTs (i.e., less than about 20% by weight and more preferably less than about 10% by weight long CNTs, based upon the total weight of all CNTs taken as 100% by weight).

Although the number of walls affects the outer diameter of the CNTs, it is generally preferred that the CNTs used in the present invention have an outer diameter of from about 0.5 nm to about 20 nm, more preferably from about 0.6 nm to about 10 nm, and even more preferably from about 0.7 nm to about 5 nm. The outer wall (sidewalls) of the CNTs can be pristine, or they can contain functional groups, including alcohols, amines, acids, other dispersing agents, and dopants. Pristine sidewalls (i.e., those that are substantially free of holes and/or functional groups) are particularly preferred. The end walls of the CNTs can also contain functional groups, such as those above, but are preferably substantially free of functional groups.

The precursor composition preferably comprises from about 0.1 to about 2.5% by weight short CNTs, more preferably from about 0.2 to about 2% by weight short CNTs, and even more preferably from about 0.3 to about 1.5% by weight short CNTs, based upon the total weight of the composition taken as 100% by weight. When present, the precursor composition preferably comprises from about 0.05 to about 1% by weight long CNTs, more preferably from about 0.1 to about 0.5% by weight long CNTs, and even more preferably from about 0.1 to about 0.25% by weight long CNTs, based upon the total weight of the composition taken as 100% by weight. The total CNT concentration (from all sources) in the composition is preferably from about 0.1 to about 3.5% by weight total CNTs, more preferably from about 0.1 to about 2% by weight total CNTs, and even more preferably from about 0.1 to about 1.25% by weight total CNTs, based upon the total weight of the composition taken as 100% by weight. In some embodiments, the composition can consist essentially, or even consist, of the carrier and CNTs.

Any suitable carrier can be used in the invention to disperse, dissolve, suspend, and/or otherwise evenly distribute the CNTs throughout the composition and avoid aggregation and/or bundling of the individual tubes of the short and/or long CNTs in the composition. The CNTs are preferably evenly distributed throughout the carrier to form a substantially homogeneous mixture. Exemplary carriers include polymers (both solid and liquid), solvent systems (e.g., organic, inorganic, and/or aqueous), surfactants, and the like. The suitability of a given carrier will depend upon the specific method used to ultimately form the film. Preferably, the carrier is one that can be easily removed from the system once the composition has been applied to a substrate surface. Alternatively, conductive and/or transparent carriers may be used, which can be left in the system for film formation.

In use, a layer of the precursor composition is formed on a substrate surface. Suitable substrates include plastics, glass, metals, ceramics, paper, silicon. Suitable plastics include PET, polyimides, polyester, PEEK, and the like. The layer can be formed by spin-coating, screen-printing, spraying, dipping, inkjet printing, flexo printing, graveure printing, Aerosol Jets printing, wire rod printing, and slot die printing. In some embodiments, an optional intermediate layer can be present on the substrate surface, in which case the layer of precursor material is applied adjacent the intermediate layer. Exemplary intermediate layers include conductive polymer binders, adhesion promoters, and the like, which help facilitate adhesion of the CNT film to the substrate surface.

Regardless of the embodiment, the carrier can then be substantially (and preferably completely) removed from the layer to leave behind a CNT film. Removal of the carrier can occur before, after, or substantially simultaneously with film formation. In one or more embodiments, the layer is heated to a temperature above the degradation temperature or boiling point of the carrier. In alternative embodiments, the layer is washed with an appropriate solvent to remove the carrier from the film. Regardless of the embodiment, removal of the carrier results in a film comprising (consisting essentially or even consisting of) CNTs (i.e., the short CNTs and optionally long CNTs). Thus, the film is preferably essentially free of any carrier, which means that at least about 85% by weight of the carrier has been removed, preferably at least about 90%, and more preferably at least about 99% by weight of the carrier has been removed based upon the initial amount of carrier in the composition (before removal) taken as 100% by weight. It will be appreciated that, depending upon the type of carrier, some residual carrier may remain in or on the film without departing from the spirit of the invention, as long as the carrier is removed to an extent that the residual carrier does not interfere with the properties (e.g., conductivity, transparency, etc.) of the film. The weight ratio of short to long CNTs (when present) in the film is preferably from about 1:4 to about 5:1, more preferably from about 1:2 to about 3:1, and even more preferably from about 1:1 to about 2:1.

The inventive films will have an average thickness of from about 50 nm to about 150 μm, more preferably from about 100 nm to about 50 μm, and even more preferably from about 100 nm to about 1,000 nm. The average thickness can be determined by taking the average of thickness measurements (e.g., using an ellipsometer) at five different locations of the film. It will be appreciated that multiple films can also be stacked if necessary to achieve the desired thickness. Advantageously, the inventive CNT films having an average thickness of from about 100 nm to about 1,000 nm will have a percent transmittance of at least about 50%, preferably at least about 75%, and even more preferably at least about 85% at wavelengths of from about 540 to about 560 nm. The inventive films will also preferably have a sheet resistance of less than about 100,000 Ω/sq, more preferably less than about 10,000 Ω/sq, and even more preferably less than about 1,000 Ω/sq. Advantageously, not only are the inventive films transparent and conductive, they are also flexible. That is, the inventive films will not crack and/or lose conductivity after being subjected to a mandrel bend test and/or a crease test. In the mandrel bend test, the films are wrapped around a cylindrical mandrel with a tapered diameter to check for cracks or failures in the film. The present films can be wrapped around the smallest diameter without cracking or losing conductivity. In the crease test, the films are folded over on each other to form a crease in the film, which is then checked for cracks or failures. Additional advantages of the invention will be apparent from the working examples below.

As used herein, the phrase “and/or,” when used in a list of two or more items, means that any one of the listed items can be employed by itself, or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration and nothing therein should be taken as a limitation upon the overall scope of the invention.

### Example 1

### Formulation of a Fugitive Polymer Carrier for CNTs

In this procedure, 100 grams of 5-sulfosalicylic acid (SSA) were dissolved in 900 grams of polytetrahydrofuran by mixing on a stir plate to make a stock solution. Various CNTs in differing amounts were added to the stock solution by mechanical dispersion using 3-roll milling.

### Example 2

### 1% Short CNT Solution

A 1% by weight solution of P-3 short carbon nanotubes (SWNTs, nominal length 600 nm; Carbon Solutions, Riverside, Calif.) was prepared using the stock solution from Example 1. This solution was screen printed onto a PET film using a 390 mesh screen on an Atma AT-70TD screen printer, and then heated in a HIX convection oven at 350° F. at a rate of 4.1 in/min for about 12 minutes to decompose the fugitive polymer, leaving behind the CNT film. A comparative 1% by weight solution of CNTs of standard length (˜1,000 nm; SG-76 from SWeNT, Norman, Okla.) was also prepared using the stock solution in Example 1, and screen printed as described above. Table 1 shows the resistance measurements and transmittance (transparency) measurements of two different sheets for each CNT formulation. Resistance was measured using a Miller FPT-5000 4-point probe and transmittance was measured at 550 nm using a UV-Vis spectrometer.

TABLE 1
Transmittance and resistance measurements

| | % Transmittance | Sheet Resistance (Ω/sq) |
|---|---|---|
| 1.0% P-3 | | |
| wet on wet | 90.5 | 43000000 |
| 1 pass | 91.5 | 50200000 |
| 1.0% SG-76 | | |
| wet on wet | 73 | 2434 |
| 1 pass | 73 | 2449 |

### Example 3

### Short CNT Solutions of Varying Concentrations

Solutions of various concentrations of P-3 short carbon nanotubes (Carbon Solutions, Riverside, Calif.) were prepared using the stock solution from Example 1. These solutions were screen printed onto a PET film using 460 mesh and 380 mesh screens on an Atma AT-70TD screen printer, and then heated in a HIX convection oven at 350° F. at a rate of 4.1 in/min for about 12 minutes. Table 2 shows the resistance measurements and transmittance measurements of each CNT formulation. Resistance was measured using a Miller FPT-5000 4-point probe and transmittance was measured at 550 nm using a UV-Vis spectrometer.

TABLE 2
Transmittance and resistance measurements for
increasing CNT concentration

| | | Sheet | | Sheet |
|---|---|---|---|---|
| % by | % | Resistance | % | Resistance |
| weight | Transmittance | (Ω/sq) | Transmittance | (Ω/sq) |
| CNT | 460 Mesh | | 380 Mesh | |
| 0.1% P-3 | 97 | 30,000,000 | 95 | 33,000,000 |
| 0.2% P-3 | 96 | 7,500,000 | 90 | 8,000,000 |
| 0.5% P-3 | 80 | 170,000 | 80 | 180,000 |
| 1% P-3 | 64 | 12,000 | 62 | 18,000 |

### Example 4

### Solutions of Short CNTs with Standard CNTs

Solutions of various concentrations of P-3 short carbon nanotubes (Carbon Solutions, Riverside, Calif.) with standard length TWNT carbon nanotubes (5-30 μm; Cheap Tubes, Inc., Brattleboro, Vt.) were prepared using the stock solution from Example 1. These solutions were screen printed onto a PET film using 460 mesh and 380 mesh screens on an Atma AT-70TD screen printer, and then heated in a HIX convection oven at 350° F. at a rate of 4.1 in/min for about 12 minutes. Table 3 shows the resistance measurements and transmittance measurements of each CNT formulation. Resistance was measured using a Miller FPT-5000 4-point probe and transmittance was measured at 550 nm using a UV-Vis spectrometer.

TABLE 3
Transmittance and resistance measurements for
varied short CNT concentration

| | | Sheet | | Sheet |
|---|---|---|---|---|
| | | Resistance | % | Resistance |
| | % Transmittance | (Ω/sq) | Transmittance | (Ω/sq) |
| % CNT | 460 Mesh | | 380 Mesh | |
| 0.5% TWNT | 60 | 1800 | 58 | 800 |
| 0.1% P3 | | | | |
| 0.5% TWNT | 59 | 1100 | 55 | 1000 |
| 0.2% P3 | | | | |
| 0.5% TWNT | 59 | 1500 | 55 | 850 |
| 0.5% P3 | | | | |

We claim:

1. A method of increasing conductivity of a transparent, conductive film without significantly decreasing transparency comprising:
providing a composition comprising a first plurality of carbon nanotubes and a plurality of short carbon nanotubes; and
forming a film from said composition.

2. The method of claim 1, wherein said film is flexible.

3. The method of claim 1, wherein said film has a sheet resistance of less than about 100,000 Ω/sq.

4. The method of claim 1, wherein said film at an average thickness of from about 100 nm to about 1,000 nm, has a % transmittance of at least about 50%, at wavelengths ranging from about 540 to about 560 nm.

5. The method of claim 1, wherein said first plurality of carbon nanotubes have a nominal tube length of greater than about 1 μm.

6. The method of claim 1, wherein the weight ratio of said plurality of short carbon nanotubes to said first plurality of carbon nanotubes in said composition is from about 1:4 to about 5:1.

7. The method of claim 1, wherein said plurality of short carbon nanotubes are present in said composition at a level of from about 0.1% to about 2.5% by weight, based upon the total weight of the composition taken as 100% by weight.

8. The method of claim 1, wherein the total concentration of carbon nanotubes in said composition is from about 0.1 to about 3.5% by weight, based upon the total weight of the composition taken as 100% by weight.

9. A method of forming a transparent, conductive film, said method comprising:
providing a substrate having a surface;
providing a precursor composition comprising a plurality of short carbon nanotubes in a carrier;
forming a layer of said precursor composition adjacent said substrate surface; and
removing said carrier to yield said film.

10. The method of claim 9, said precursor composition further comprising a plurality of long carbon nanotubes in said carrier.

11. The method of claim 9, wherein said forming comprises screen-printing said composition onto said substrate surface.

12. The method of claim 9, wherein said removing comprises heating said composition to a temperature above the degradation temperature or boiling point of said carrier.

13. The method of claim 9, wherein said removing comprises washing said layer with a solvent.

14. The method of claim 9, wherein said film is essentially free of any carrier.

15. The method of claim 9, wherein said film has an average thickness of from about 50 nm to about 150 μm.

16. An article comprising:
a substrate having a surface; and
a transparent conductive film adjacent said substrate surface, said transparent, conductive film comprising a plurality of short carbon nanotubes.

17. The article of claim 16, wherein said transparent conductive film further comprises a plurality of long carbon nanotubes.

18. The article of claim 17, wherein the weight ratio of said plurality of short carbon nanotubes to said plurality of long carbon nanotubes in said film is from about 1:4 to about 5:1.

19. The article of claim 16, wherein said film consists essentially of carbon nanotubes.

20. The article of claim 16, wherein said film has an average thickness of from about 50 nm to about 150 μm.
